(19) United States
(12) Patent Application Publication
(10) Pub. No.: US 2014/0256395 A1
(43) Pub. Date: Sep. 11, 2014

(54) METHOD AND SYSTEM FOR AGGREGATING BETS FOR LOTTERIES OR GAMING WITH GRAPHICAL REPRESENTATIONS, MULTI-GAME PLAY WITH ONE BET, AND COMBINATIONS OF ONLINE AND OFFLINE PLAYERS

(71) Applicant: Arthur L. Cohen, Cupertino, CA (US)

(72) Inventors: Arthur L. Cohen, Cupertino, CA (US); John R. Haggis, San Jose, CA (US); Paul Wicks, Larkspur, CA (US)

(73) Assignee: Arthur L. Cohen, Cupertino, CA (US)

(21) Appl. No.: 14/198,544

(22) Filed: Mar. 5, 2014

Related U.S. Application Data
(60) Provisional application No. 61/773,363, filed on Mar. 6, 2013.

(51) Int. Cl. G07F 17/32

(52) U.S. Cl. CPC G07F 17/329
USPC 463/17

(57) ABSTRACT

A method of collecting, graphically displaying, managing, and directing individual contributions and distributions of pooled funds and/or investments online to enable participants to share in the purchase of lottery tickets, to bankroll casino table game players, to invest, or to bet, alone or in any combination. A Pool-in-Pool method is included to allow some proportion of a pool to be used to buy into other pools, thereby enabling players to increase the odds of winning a given prize by increasing the number of games to which their bets apply and the jackpots to which they have some claim. The method is enhanced by user determined combinations of games combined within a pool and participation of pools in varying percentages of other pools, allowing users to set the statistical advantage sought and to determine the level of acceptable rate of loss.

### CROSS REFERENCES TO RELATED APPLICATIONS

The present application claims the benefit of U.S. Provisional Patent Application Ser. No. 61/773,363, filed Mar. 6, 2013 (Mar. 6, 2013).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates generally to gaming lotteries, casino-like games, forms of legal betting, and investments. More specifically, it relates to practices for pooling multiple contributions by a number of individuals for the purpose of increasing the odds to win a game or wager, or to win from a group of games. The invention finds application and extends into many aspects of social networking via the Internet, enhancing the gaming objective of such activities by encouraging and facilitating communication between the individuals in the pooling groups or in potential pooling groups.

2. Background Discussion

Lotteries and gambling have been part of American culture since the early 1800's. Early in American history, legislatures authorized lotteries to fund schools, roads, bridges, and other public works. But recurring lottery scandals and a general backlash against legislative corruption following the Panic of 1837 contributed to already existing anti-lottery sentiments, and during only the brief span from 1844 to 1859, ten new state constitutions contained lottery bans. By 1890, lotteries were prohibited in every state except Delaware and Louisiana.

Before the advent of government-sponsored lotteries, many illegal lotteries thrived, such as numbers games. The first modern government-run US lottery was established in Puerto Rico in 1934, followed by New Hampshire in 1964; today, lotteries are operated in 43 states, the District of Columbia, Puerto Rico, and the Virgin Islands; The most recent US lottery obtaining legal sanction was in Arkansas; its voters approved a lottery in the 2008 election.

The first modern US joint lottery game was formed in 1985 in Maine, New Hampshire, and Vermont. In 1988, the Multi-State Lottery Association (MUSL) was formed with Iowa, Kansas, Missouri, Oregon, Rhode Island, West Virginia, and the District of Columbia as its charter members; it is best known for Powerball, specifically designed to create large jackpots. Another joint lottery, The Big Game (now called Mega Millions), was formed in 1996 by six other lotteries as its charter members.

Instant lottery tickets, also known as scratch cards, were introduced in the 1970s and have become a major source of lottery revenue. Some lotteries have introduced keno and/or video lottery terminals (slot machines in all but name).

Individual lotteries often feature three-digit and four-digit games akin to “numbers games,” a five number game, and a six number game (the latter two often having a jackpot). Some lotteries also offer at least one game similar to keno. Presently, many US lotteries are used to support public education systems.

In 2013 the United States legalized state run lotteries in nearly every US state. Most popular state run lotteries now include huge jackpot prizes with odds as great as 1:179,000,000 (i.e. Mega Millions, Super Lotto, etc.). As suggested above, some state lotteries enable “Multi-State” participation. This means that the jackpot grows after each drawing until there is a jackpot winner. The weekly drawings always have winners of various levels for which winnings are distributed. However, the lottery jackpot carries over in successive weeks and continues to grow until there is a jackpot winner. The excitement grows in proportion to jackpot growth, and jackpots have grown as high as $600 million dollars before a winning ticket is picked. The larger the jackpot the faster the jackpot grows as more and more people play to win the large dollar winnings. The level of excitement increases as the jackpot grows and more and more people get caught up in the dream of winning the big jackpot.

People naturally seeks methods to increase their odds of winning. A popular method of increasing the odds of winning a particular lottery has been for groups of people to jointly purchase a large number of tickets. This technique, known as “pooling,” is especially popular in corporate office environments and are, aptly, known as “office pools.”

Office pools are now very popular, and derivative pooling activities organized to win lotteries are common in countless arenas. The pooling activity is sometimes operated as a kind of syndication, in which one party in an office manages the collection and purchase of the tickets and distributes the purchased tickets before a lottery number is chosen for a given lottery event. The tedious tasks of purchasing, organizing, distributing the tickets and (hopefully) later the division of the winnings with the various participants in any given pool is extremely time-consuming and labor intensive. Furthermore, disputes have predictably arisen from office pool activities. A typical dispute is that someone—a regular pool participant, for instance, someone who joins a pool and plays on a weekly basis—has been excluded from the pool because he or she was temporarily out of town and failed to expressly opt in, but assumes nonetheless that he would and should be included because he will pay for a portion of the pool on his return. When that person is not included in the pool, a legal dispute arises based on a kind of quasi contract theory from a history of dealing between the individual and the syndication. Other challenges include managing office pool activity, including the seemingly simple task of copying tickets purchased for distribution to the various members of the given pooling activity, again, a very time-consuming activity.

While various online sites offer have ad-hoc syndication service, none of the known services provide the management, significant odds improvement, and pool-in-pool activity, as well as the ability to pool bets together with offline and online players. The integration of these services provides a unique service not taught in any prior art.

For example, the pooling method taught by Amada et at in U.S. Pat. No. 7,527,556 specifies not only fractional sales of individual tickets as the pooling mechanism, but also requires in every claim that the agent selling the fractional tickets be the Lottery Operator, the very same entity running the lottery and originating the tickets, “ . . . which can be a governmental entity, such as a state lottery, or a representative of a state . . . . The lottery operator also can include a third-party provider that operates the lotto games for a state or other governmental entity.”

In contrast, the methods of the present invention are practiced by a third-party service with no official connections with any state lottery or gambling entity, other than the mere purchase of lottery tickets or bets. Whereas Amada clearly states in each and every claim that the Lottery Operator creates the tickets before offering them for purchase in whole or in fraction, the present invention pools players in an account, selling not tickets but shares of a social group formed for the purpose of some kind of gaming. The lottery tickets are purchased or bets are placed after the group is formed and the organizing comes to a conclusion. Thus, and summarily stated, whereas Amada describes creation of tickets, pooling of tickets and selling of the tickets from pools, but again sold to individual players, the present invention pools the players with their financial contributions, and the later purchase of lottery tickets or gaming bets is incidental to the pooling process. The inventive method then adds further dimensions to the process by increasing the odds of winning by having the pool own shares in other pools and increasing gaming betting levels past odds thresholds.

Several known pooling methods are found through websites and thus provided by online service providers. These include, among others: LotteryTicketPool.com; 5LottoMonkeys.com, and the company's mobile device App, “MegaMonkeys”; LottoGopher.com; TheLotter.com; MyFreeLotteryPool.com; LottoMagic101.net; PlayHugeLottos.com; WinTrillions.com; Online-Lottery-Pool.com; YouPlayWePlay.com; Onlineofficepool.com; BuyLottoOnline.com; JackpotBuddy; and CongaLotto.com. However, neither the above-described '556 patent to Amada et al, nor the above-identified commercially available services reflect the current state of the art of which the present inventors are aware. Reference to, and discussion of, this background art is intended to aid in discharging Applicants' acknowledged duties of candor in disclosing information that may be relevant to the examination of claims to the present invention. However, it is respectfully submitted that none of the above-indicated services disclose, teach, suggest, show, or otherwise render obvious, either singly or when considered in combination, the invention described and claimed herein.

### BRIEF SUMMARY OF THE INVENTION

The present invention provide a method for collecting, graphically displaying, managing, and directing individual contributions and distributions of pooled funds online for the purposes of enabling players to share in the purchase of bets made for lottery tickets or other casino-like gaming. It also provides a method whereby the pools for which bets have been aggregated may buy into other pools, in some proportion, to increase player odds of winning any given prize. This method, called “pool-in-pool” or “viral pooling” allows players to make single bets into a pool at the same time playing multiple games. The invention further describes methods for players to pool bets while directly interacting with offline players. This method of combining offline bets with online bets into a pool allows players to increase the odds of winning any given bet. The invention builds a pooling social network (PSN) for interactive online and offline activity.

It is thus a primary and principal object of the present invention to enable online lottery and gaming players to join a Pool that collects and organizes financial contributions and distributions. A further object is to benefit Pool participants by increasing their odds of winning any given prize. A Pool managed and organized by a PSN helps ensure that the Pool Members are paid their fair share of winnings and reduces disputes among players over payouts. PSNs also help generate a sense of community because they group together people in a synchronized cause or goal.

It is a further object of the present invention to represent the various attributes of a pool with an infographic, to aid the players in searching and selecting a pool to join. The infographic may comprises a two-dimensionally represented three dimensional cylinder whose width is proportional to the odds of the game to which it is attached, and whose height is proportional to lottery jackpot or potential payout of the game. A level indicator within the cylinder indicates the total share amount of the pool already purchased or the share remaining available. Another level indicator within the cylinder indicates the percentage of the pool owned by the current player on whose account page the infographic is viewed.

It is a further object of the present invention to update the infographic at the time a pool closes to further purchases. In the event that less than 100% of the shares of the pool were purchased, the infographic shows readjusted ownership percentages and jackpot share eligibility. When the pool closes in this case, the share percentage remaining is removed. The share percentage purchased is promoted to 100%, and the player's share percentage is promoted proportionately. At the same time, the size of the pool in total dollars to apply to the game—total tickets to be purchased in the case of a lottery—is reduced to the dollar amount in the pool account at the time of closure. Likewise, the odds are adjusted down in keeping with the new, reduced value of the pool.

It is another object of the present invention to enable Pools to buy into other Pools for the purpose distributing the share holdings across multiple gaming bets without direct additional costs. This Pool-in-Pool or Viral Pool activity helps players increase their odds of winning by playing additional lottery or casino-like gaming activities.

It is a further object of the present invention to use distributed shares across multiple lotteries as an opportunity for Pool Players to play in more than one lottery at a time and thus increases their odds of winning some amount from among the multiple lotteries. Players can purchase a small or large percentage of any given Pool and have the benefit of playing multiple lotteries without additional costs through a simple and straightforward transaction.

It is a further object of the present invention to expand odds of winning by expanding pool purchases across multiple games of a variety of types, including but not limited to lotteries, casino-type games, investments, and group purchases. The PSN improves the betting reach of each individual player without increasing the direct cost of participating in more than one gaming activity. The player can make one bet in a Pool and that Pool can participate in various other Pools all of which are betting on various different gaming activities.

It is yet another object or feature of the present invention to create Pool Bets in casino-type games with online and offline players. Players benefit from these Pooled online-offline combination bets allowing casino players interact with online players in real-time to make Pooled bets. Established PSNs greatly enhance the ability to build large Pooled bets. This benefits offline players because they can build a large Pool quickly and it benefits online players who can join a Pool without traveling to a casino site.

It is still another object of the present invention to increase odds for Pool Players in casino-like games by having the collective level of the Pool Bet exceed casino thresholds for higher-odds bets. Online and offline players benefit from the ability to build Pooled bets from the PSN to help increase winning results of a given casino game. Because the bets are larger, casinos may have better winning payoff odds for larger Pooled bets.

A further object of the present invention to facilitate the application of the pooled funds to any investment which may yield a jackpot, payoff, reward or other remuneration, and to manage the distribution of said jackpot, payoff, reward or remuneration to the Pool Players. The PSN manages the distribution of funds to various players that are a member of a winning Pool. Players are assured that their fair share of a given Pool's winnings will be distributed accurately and quickly.

A still further object of the present invention to provide tools to the Pool Players to cultivate social networking among them for the purposes of building Pools of people for gaming, facilitating one person alerting another of interesting games or groups, and exchanging other information, knowledge, or experience. The PSN will allow all players to establish and/or create their own selective Pools for their own friends and family to join. Building personal PSNs with custom Pool features helps promote the PSN, hence growing the size of future Pools and future winnings by increasing the odds in any given game.

It is a further object of the present invention to alert and disclose to visitors, members, and/or Pool Players the existence and attributes of any number of lotteries or casino-type games. Players benefit from the PSN's reach to various friends and family of Pool players by helping to increase the participation of members in Pools. As the number of Pools grows within the PSN, the odds increase for all members of the PSN to win some portion of a jackpot prize someday.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic block diagram of the inventive method for creating and managing lottery-buying pools and calculating the cost of joining the pool, fees extracted, and the distribution of winnings from the pool;

FIG. 2A is a schematic block diagram showing use of an infographic image showing a pool with particular kinds of attributes for easy analysis and selection;

FIG. 2B is a schematic block diagram of the same kind of infographic image as that of FIG. 2A, showing a pool having different characteristics;

FIG. 3 is a highly schematic diagram illustrating the effect of closing a pool with less than 100% buy-in using a transformation in the infographic to signify the changes in odds of the pool and the jackpot claim percentage of a given player;

FIG. 4A is a schematic block diagram illustrating a possible linear Pool-In-Pool-Action (PIPA) scheme and its implications on the methods of calculating and distributing pool winnings;

FIG. 4B is a schematic block diagram illustrating a circular PIPA purchase and distribution network; and

FIG. 5 shows an alternative view of the method of FIG. 1, this view illustrating a method for online players to pool with an offline player for casino-style betting.

### DETAILED DESCRIPTION OF THE INVENTION

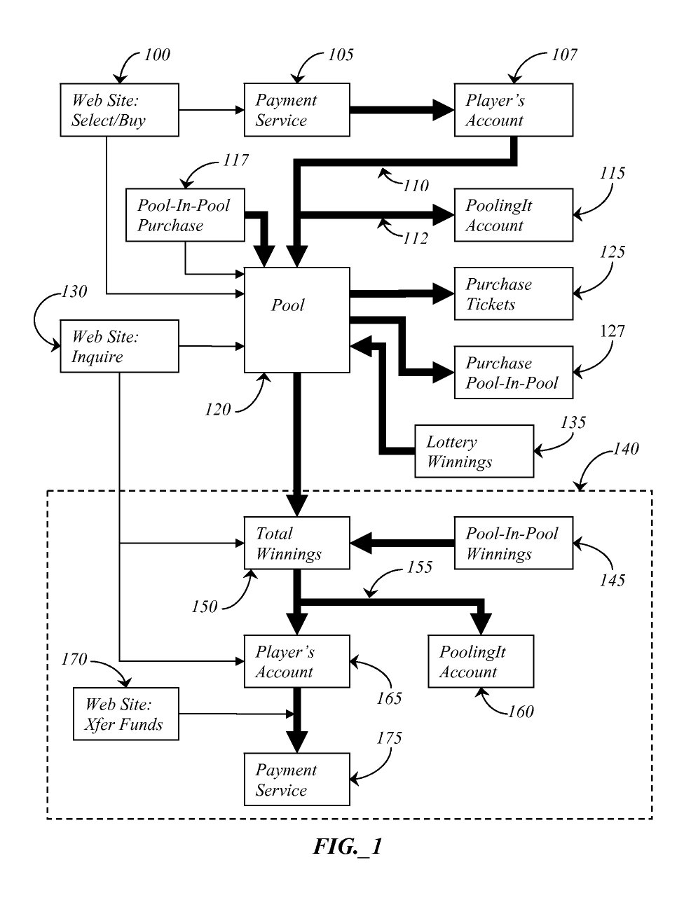

Referring to FIGS. 1 through 5, wherein like reference numerals refer to like components in the various views, there is illustrated therein a new and improved pooling social network “PSN,” the system and service which is known as “PoolingIt.” The PSN requires an extensive vocabulary of terms that describe the many functions of the PSN for various player actions commonly occurring in daily pooling transactions. All of these terms are used in describing the methods of the present invention. To facilitate reference, the relevant terms are set out in capital letters below, with their respective definitions following. Thereafter, in the specification generally, special terms are shown with initial caps only.

POOL: As used herein, “Pool,” with an initial capital letter, shall mean a pool formed, forming, or available to be formed under the systems and methods described below.

POOL OPEN and OPEN POOL: Pool allows for purchasing a percentage of that pool.

POOL CLOSED: Pool is no longer available to buy-in. There is “no action” on this Pool.

POOL-ON: Pool is activated and action is on. Once a Pool is activated it is an “OPEN POOL”.

POOL-IN-POOL ACTION: An action in which money from one Pool is employed to purchase a percentage of another Pool. This increases the jackpot of the purchasing Pool. The purchasing Pool also has increased the odds of winning any given lottery because it enables the player to buy into multiple lotteries with one Pool purchase.

POOL PLAYER: Any customer (individual or corporate) that purchases equity in a Pool.

POOL OWNER: Once a Pool closes, Pool Players are the same as Pool Owners.

POOL EQUITY: This refers to the percentage of ownership of any given Pool a Pool Player owns. This percentage of ownership is variable till the pool is closed based on the percentage of the total Pool purchased.

POOL CYLINDER: Graphical representation of pools. This is a three-dimensional representation indicating various aspects of a given pool. Elements of the Pool represented by the graphic are discussed in detail in the drawings and their descriptions, but they include Odds (width of graphic), Jackpot payout level (height of graphic), a given player's percentage of the Jackpot (lower shading separation line) and the percentage of the pool purchased by all the players (upper shading separation line).

TARGET POOL: This is the Pool that has been purchased by another Pool in a Pool-in-Pool action event.

POOL SIZE: This refers to the number of tickets an Open Pool is subscribed to purchase. The initial minimum sized Pool is 120 tickets. Larger or smaller size Pools are standardized to be designed in multiples of 120. As an example, there could be a 240 ticket pool or a 360 ticket pool etc.

DYNAMIC POOL SIZE: This term means the number of tickets a given Pool has action in. The ticket size of a Pool will grow in the case of Pool-in-Pool action. A Pool's ticket size may shrink in the event Pool Buy-in is less than 100%. In such cases, a minimum percentage shall be set to determine a Pool-On status.

LOTTERY CLOSED: This term signifies the time at which a given Lottery is no longer available for ticket purchase. Any Pool must close at a given specified time before the actual closing of a given lottery. A Pool, therefore, must close with sufficient time remaining to for the Pool to purchase the subscribed number of tickets available for that Pool. Once a Lottery closes and the winning numbers are drawn, a Pool can then ascertain whether any of its purchased tickets are winners and the value of the winning tickets. Once the winnings are calculated for a given Pool, the winnings can be calculated for all Pool owners and players.

REMOTE POOL: This is a pool that has had a percentage purchased by a Primary Pool.

POOL DISTRIBUTION: This term means an action to calculate winnings for a given Closed Pool connected to other Pools in a Pool-in-Pool action event.

POOL MEMBER: The purchaser (individual or entity) that purchased a given percentage of a Pool.

POOL BUDDY: Fellow Pool Member of a Primary Pool. A Pool Buddy may also be connected to a Pool Member who is a member of a Remote Pool

PRIMARY POOL: Current Open Pool in which a Pool Member is participating.

MULTIPLE POOL-IN-POOL ACTION: Where one Pool has purchased percentages of more than one other Pool. First we define the percentage a given Primary Pool is buying of a given Target Pool. The Primary Pool's money is used to purchase a percentage of the Target Pool, which will likely be a different percentage than that allocated from the Primary Pool.

MULTIPLE POOL-IN-POOL ACTION (Symmetrical): In this scenario, the same percentages are allocated from the Primary Pool to each of the Target Pools.

MULTIPLE POOL-IN-POOL ACTION (Asymmetrical): In this scenario, different percentages are allocated from the Primary Pool to each of the Target Pools.

CIRCULAR POOL-IN-POOL ACTION: The circumstance in which two Pools (i.e., Pool A and Pool B) have action in one another's Pool.

COMPLEX POOL-IN-POOL ACTION: Wherein more than two Pools (i.e., Pool A, Pool B . . . Pool N1 . . . Nx) have action in each other's Pools. Complex Pool-In-Pool action may involve several permutations of connected Pools.

POOL CLOSER RULE: To calculate Pool winnings value, the various Target Pools must be closed for a given Pool. Once all Pools are closed, a minimum of five additional iterations of the winnings from the various Target Pools must be calculated to determine the correct value of any given Pool.

POOL ODDS: These are the odds for any given Lottery that a Pool is purchasing. The odds to win increase the larger the number of tickets purchased by a Pool.

POOLINGIT PARTICIPATION: PoolingIt's action in any given Pool which PoolingIt purchases various percentages of any given Pool with its own financial resources. PoolingIt participates in all Lottery games and therefore participates in all lottery winnings

POOLINGIT PARTICIPATION FEE: PoolingIt charges a pre-determined fee for all PoolingIt transactions involving purchases of Pools. This Fee may vary depending on a Pool Member's status. The fee is included in the Pool's cost per percentage. For instance, to purchase 5% of a 120 ticket Pool in which each ticket costs $1, the cost per percentage point is: $1.80. Therefore, the cost to purchase 5% of this given Pool would be calculated: 5*$1.80=$9. To purchase 50% of this Pool would cost: 1.80*50=$90. If the Pool is participating in Pool-in-Pool action, the number of tickets the Pool would have action in increases; however, the cost to participate in the Pool does not. This gives the Pool Member leverage for their purchasing dollars. For instance, if Pool A with 120 tickets had two Target Pools in which Pool A allocated 10% of its value into each of the Target Pools each with 120 tickets, the effective result would be the Pool Member would be playing 360 tickets for the same $90 cost of buying 50% of Pool A. Pool A would have various odds in its Target Pools B and C, respectively. The actual ownership in Pools B and C would be calculated as if Pool A was purchasing Pools B and C percentages as any other Pool Member would pay.

POOLINGIT CREDITS: POOLINGIT provides a rewards program for active and returning members. Members are rewarded for joining Pools. Members receive CREDITS which can be used to purchase Pool percentages. The ratio of CREDITS to purchases is pre-determined by PoolingIT. A separate CREDIT status is provided to all Members.

MEMBER STATUS: PoolingIt members may have various status levels enabling them to earn Credits faster. Status levels are earned based on number of Pools that a member participates in any given month.

POOL MANAGER: A member of a Private Pool who manages decisions regarding: a) Viral status; b) Members allowed to join; and c) Lotteries in which to participate.

VIRAL POOLS: The term “Viral Pools” is the marketing term for what is technically a Pool-in-Pool action event. When a Pool goes “Viral” it means that Pools can buy into other Pools, thus increasing the odds by as much as at least 100% to win various jackpots. Members are able to participate in Viral Pooling without any direct costs. The PSN controls the Viral Pooling action and makes it happen when someone buys into any Pool. Your odds increase to win money which is what PSNs are all about.

DIRECT POOLS: POOLS in which members have purchased equity at the first level of a Viral Pool.

ASSOCIATED POOLS: A Pool that must be purchased by another Pool.

FAMILY POOLS: A group of Associated Pools.

PRIVATE POOLS: The term “Private Pools” refers to Pools customized by members who wish to create a personalized Pool and who may also wish to invite participation only by friends and family. Essentially, it's a “private” pool designed for those who want the PSN to handle the logistics for purchasing tickets online and distributing winnings among the various member-owners of a particular customized and Private Pool. Private Pools have a “Pool Manager”, the member who initiates or “creates” the Pool and who decides what members can join, who can play, and whether the Pool will be allowed to go “Viral”.

POOL ADS: These are advertisements created by PSN members and marketed to various members based on member requests. Members have an option to receive various “types” of ads, and PSN members can direct ads to PSN member requests. The cost of PSN ads will be based on how many members view or click through on a particular ad sent.

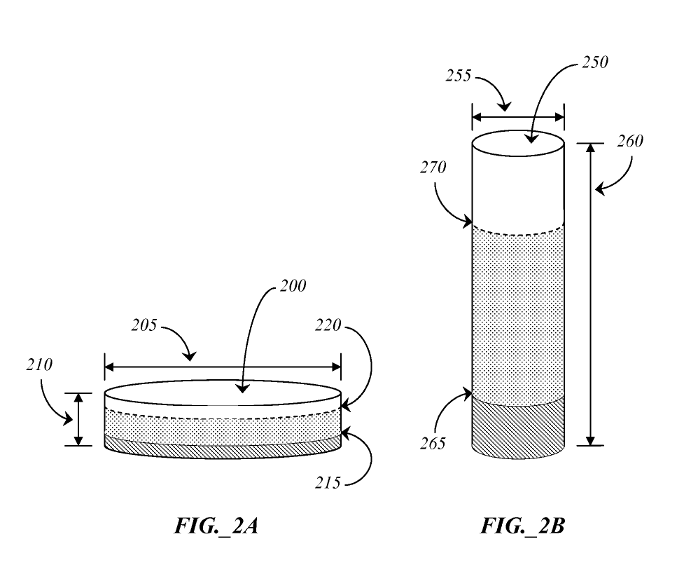

Referring now to FIG. 1, there is illustrated therein a method for creating and managing lottery-buying pools and calculating the cost of joining the pool, fees extracted, and the distribution of winnings from the pool. Thin arrow lines signify activities on the web site and thick arrow lines signify the flow of funds. The process starts with a player accessing the pooling service web site 100 using a network connected computer, laptop, smartphone, or other network connectible mobile device. There the player can search, browse, inquire, and observe the properties of the various pools available (see FIG. 2) for purchase. Based on the properties, the player may select a given pool for purchase. The player may transfer funds from a payment service 105 to the player's account 107 on the pooling web site. The player purchases a percentage share of the pool 120 through a “buy-in” transaction 110, with a predetermined percentage used as a fee sent 112 to the pooling service account 115. This transaction is described by the following formulas.

PoolSizeTickets: Number of tickets allocated for this pool.

TicketCostDollars: Cost of tickets in this lottery ($1)

FeePercent: Pooling Service global fee percentage.

PoolingItBuyInPercent: Percentage share bought by Pooling Service.

PlayerPercent: Percent of pool (% of potential winnings) player is purchasing.

PoolSizeDollars: Size of pool in dollars.

CostPerPercent: Dollar cost of each percentage share of pool.

PlayerCost: Dollar cost of players percentage of pool buy-in.

PoolingltFee: Dollar fee the Pooling Service will collect on the transaction.

PoolSizeDollars=PoolSizeTickets×Ticket CostDollars

CostPerPercent=PoolSizeDollars×(100+FeePercent)/100/100

PlayerCost=CostPerPercent×PlayerPercent/100

PoolingItFee=PlayerCost×FeePercent/100

In addition to individual players buying into a pool, other pools may purchase a share of the pool in lieu of actual lottery tickets, in a transaction called “Pool-In-Pool-Action Purchase” (PIPA Purchase) 117. The percentage share of the pool purchased by another pool will have claim on an equal percentage of the jackpot, which will add to that buying pool's total winnings before it makes distribution to its players. Likewise, the current pool may purchase shares of other pools 125 in lieu of lottery tickets in a similar PIPA Purchase. The formulas governing the cost of the share of a pool in a PIPA Purchase are the same as the formulas governing the players' purchases.

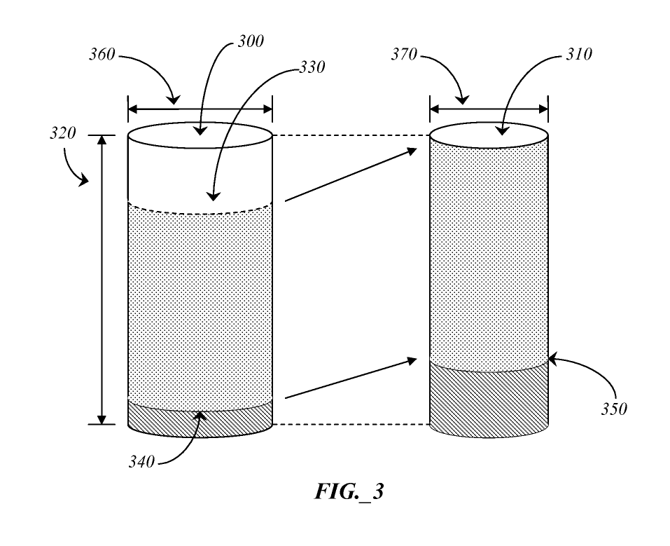

After buy-in, players may use the web site 130 to watch the evolution of the pool purchases, and to see when all shares are purchased or what percentage is purchased by the time the pool closes to purchases before the lottery. At some predetermined time before the lottery, the web site closes the pool to further purchases. The players may then use the web site 130 to view their final percentages and odds (see FIG. 3).

Referring still to FIG. 1, after closing, the pooling service buys the appropriate number of tickets 127 given by the formulas below. If the pool closes without 100% buy-in, the percentage buy-in of all the players is adjusted to reflect a larger share of a smaller pool (see FIG. 3). Note that the Pooling Service may purchase a percentage of the pool rather than a fixed number of tickets. In this case the Pooling Service will stipulate a certain percentage buy-in, but it contributes the funds indirectly during the purchase of the tickets; the Pooling Service purchases additional tickets with its own funds to cover the increased number of tickets attributed to its stipulated buy-in. In addition, since purchase of tickets requires a whole number of tickets to be purchased rather than the fractional total that results from the accumulated buy-ins, the number of tickets is rounded up to the nearest whole number. This rounding requires extra funds in the ticket purchase which come from the Pooling Service, thereby increasing their share by a small amount. The net percentage share of the Pooling Service is back calculated after closing from the total percentage of the original pool that resulted in tickets, plus the PIPA percentage, less the total player percentage. The ratio of the original pool size to the final pool size may be used to scale the buy-in percentages to final winnings-eligible percentages.

TotalPlayerPercent: Sum of all the player buy-in amounts, in percent.

PIPACost: Dollar cost of PIPA purchases in other pools.

ActualTicketsPurchased: Whole no. tickets to be bought.

ActualTicketsCost: Cost of actual tickets purchased.

ActualPoolRatio: Adjustment ratio from original pool size to final pool size. ActualPoolingltBuylnPercent: Pooling Service's winnings after pool closure.

ActualPlayerBuylnPercent: A given player's share of winnings after pool closure.

PIPACost=PIPAPercent×CostPerPercent.

ActualTicketsPurchased=ROUND_UP (PoolSizeTickets×(TotalPlayerPercent+PoolingItBuylnPercent−PIPAPercent)/100).

TotalPoolingItPercent=ActualTicketsPurchased/PoolSizeTickets×100+PIPAPercent−TotalPlayerPercent.

ActualTicketsCost=ActualTicketsPurchased×TicketCostDollars.

ActualPoolRatio=100/(TotalPlayerPercent+TotalPoolingltPercent).

ActualPlayerBuyInPercent=PlayerPercent×ActualPoolRatio.

ActualPoolingItBuyInPercent=TotalPoolingItPercent×ActualPoolRatio.

Still referring to FIG. 1, assuming the lottery has winnings 135, the pooling service determines the distribution of these winnings to pool players, to PIPA players, and to the Pooling Service. The total winnings 150 comprise the pool's lottery winnings plus any winnings 145 from PIPA purchases made by the pool in other pools. These winnings are distributed through Pooling Service accounting entries to the players' accounts 165, and to the Pooling Service's account 160. At this point, through the web site, a player may view the pool's 120 winnings, the total winnings 150, and the portion of those winnings allocated to the player in the player's account 165. Finally, the player may use the web site to transfer funds 170, including winnings, to the payment service 175 which has its own methods to further distribute funds at the players' discretion.

PoolWinnings: Payout from lottery and PIPA winnings.

PoolingItWinnings: Pooling Service's share of pool winnings

PlayerWinnings: A given player's share of pool winnings

PoolingItWinnings=PoolWinnings×ActualPoolingltBuylnPercent/100 PlayerWinnings=PoolWinnings×ActualPlayerBuylnPercent/100

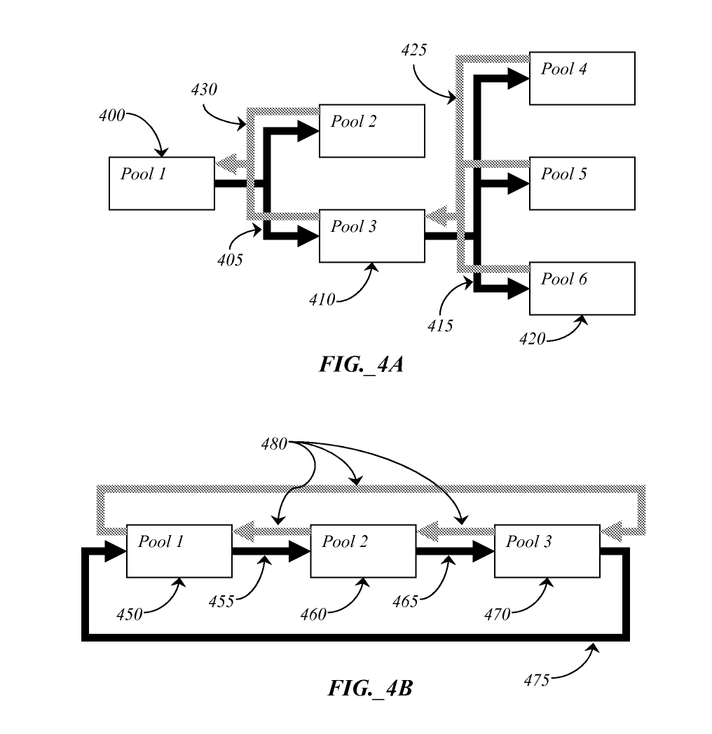

PIPA winnings require the other pools to be closed, their lotteries completed, and all the PIPA purchased-pools of those pools also closed and completed. The network of PIPA connections may become extensive and may also be circular. [See FIG. 4 for more detail on PIPA connections and winnings distributions.]

Referring next to FIGS. 2A and 2B, there is shown a method for visually illustrating the salient properties of a lottery pool for quick recognition and characterization using a unique infographic representation. This image greatly enhances a player's ability to choose the type of pool of greatest personal interest. The infographics have the following attributes.

The wide, short cylinder 200 of FIG. 2A signifies a pool with enhanced odds but low payout potential. The width 205 represents the odds, which are related to the number of lottery tickets purchased in the pool and the probability of any one ticket winning based on the structure of the lottery. Pools with greater odds tend to have higher purchase costs for a given percentage of the pool, signified by the greater volume of the same section of a wider cylinder. The height of the infographic 210 represents the jackpot payout level, in this case, a relatively low level. A player purchases a certain percentage of the total ticket value, which gives them claim to a like percentage of the jackpot. Since the height of the infographic 210 represents the jackpot payout, the player's percentage can be indicated as a vertical position or level on the cylinder, signified by the shaded or colored region at the bottom defining the level 215. Since the payout potential has some correlation to the percentage of tickets purchased, we can stretch the association and use the height of the infographic 210 to also signify the percentage of the tickets that have been purchased. The pool is created with a certain intended number of tickets. As players purchase percentages of the pool, a second level 220 is indicated in the infographic with another shading or color, signifying the total percentage of the pool that has been purchased by players.

The narrow, tall cylinder 250 of FIG. 2B signifies a pool with lesser odds but with a relatively high payout potential. The width 255 represents the odds, which are related to the number of lottery tickets purchased in the pool and the probability of any one ticket winning based on the structure of the lottery. Pools with lesser odds tend to have lower purchase costs for a given percentage of the pool, signified by the lesser volume of the same vertical section of a more narrow cylinder. The height of the infographic 260 represents the jackpot payout level, in this case, a relatively high level. The player's percentage is indicated by the shaded or colored region at the bottom defining the level 265. As with the other cylinder, the level 270 is indicated in the infographic with another shading or color, signifying the total percentage of the pool that has been purchased by players.

The infographics give players a simplified but accurate visual summary with which to make quick intuitive judgments regarding the type and potential performance of the pools. Wide, high cylinders represent pools with large jackpots and greater odds, but higher buy-in costs, whereas narrow, low cylinders represent pools with lower jackpots and lesser odds, which are more economical.

Referring next to FIG. 3, there is shown a method for changing the infographic representation of a pool to signify the changes in odds and jackpot claim percentage of a given player. At a certain time, a lottery or game will be played and/or decided. A certain amount of time before the closure, the pool must stop accepting purchases. This is called “closing” the pool. When the total of all the players' purchases amount to less than 100% of the pool by the time the pool closes, and subject to a minimum percentage, the pool remains viable (is still “on” in the Pooling Service parlance), meaning the company will purchase lottery tickets and the players in this pool will have a stake in the lottery. Because the purchases amount to a value less than the total intended number of tickets, the number of actual tickets purchased will be reduced to fit the total amount of purchases. In the event that the purchase total did not amount to a whole number of tickets, the company will fund the remainder of the final ticket to purchase a whole number of tickets.

The end result is that fewer tickets are purchased than originally intended. This reduces the odds of winning, and increases the percentage of a given player's purchase in the new total (and thus the player's jackpot claim percentage). These changes are reflected in a new infographic to be displayed after the pool closes. Because it signifies the total jackpot amount, the height of the infographic 320 remains constant between the old infographic 300 and the transformed infographic 310. The width of the infographic signifies the odds of winning and is related to the number of tickets to be purchased. Since the number of purchased tickets decreases relative to the original intended total, the width 360 of the old infographic is reduced 370 in the new one. The final change in the infographic is in a given player's percentage. Since the total amount of the pool purchased to that time becomes the new pool size, the level of the shading 330 is promoted to 100% of the new pool. Since the pool size now reflects a smaller dollar amount of tickets, the dollar purchase of a given player now represents a larger percentage of the pool. Players will see their old percentages 340 promoted to a higher percentage 350 in the new infographic, signifying their claim to a larger percentage of the jackpot.

Referring now to FIGS. 4A and 4B, there is illustrated therein a method for constructing linear Pool-In-Pool-Action (PIPA) relationships for distributing winnings from lotteries based on the relationships constructed. Dark black lines signify PIPA purchases and shaded (gray) lines signify PIPA winnings distributions. In FIG. 4A, Pool 1 400 purchases some percentage 405 of both Pool 2 and Pool 3 410 at the direction of the Pooling Service. Pool 3 410 in turn purchases 415 some percentage of Pools 4, 5, and 6 420 (indicated collectively), again at the direction of the Pooling Service. Pool 1 400 closes shortly before its lottery completes. Assuming the lottery wins, the system allocates the winnings to Pool 1. Before the winnings can be distributed to the pool member players, Pool 1 must wait for Pools 2 and 3 410 to completely gather all their winnings so that Pool 1 may receive the PIPA winnings 430 from Pools 2 and 3. However, before the winnings from Pool 3 may be distributed back to Pool 1, Pool 3 must not only complete its lottery, but also receive any winnings 425 from Pools 4, 5, and 6 420 after they are complete. This is because Pool 3 has purchased 415 some percentage of Pools 4, 5, and 6 at the direction of the Pooling Service. This process may cascade when many or all pools purchase PIPA percentages of other pools. As a practical kind of optimization, the Pooling Service may limit its winning calculations to a network of several “generations” or steps of sequential PIPA-linked pools, due to the fact that liberally assuming a PIPA purchase of less than 10%, after the several generations the winnings fraction drops to a very small fraction. For very large jackpots, the winnings may be significant even for a very small fraction, so depending on the PIPA percentage purchases, the network should wait and calculate the winnings until they reach 1 part in 100,000,000. Also for the purposes of optimization, the final generation in the sequence may distribute its winnings before its own PIPA winnings are known or collected, since their fraction contributing to the original pool (in this case, Pool 1 400) is so small. Given the potential depth of this network, the Pooling Service works more efficiently if it limits its PIPA purchases to pools whose lotteries all complete around the same time.

FIG. 4B illustrates a circular PIPA purchase network. Consider this network where Pool 1 450 purchases 455 a PIPA percentage of Pool 2 460 (possibly among others), and Pool 2 in turn purchases 465 a PIPA percentage of Pool 3 470 (possibly among others). The circular nature of the network comes about in the case that the last pool of a given sequential network, in this case, Pool 3 470, purchases 475 some PIPA percentage of the first pool of the sequence, in this case Pool 1 450. It should be borne in mind that this circular network may exist along with branching networks as illustrated at the top of the page beginning with Pool 1 400. As in that previous example, the winnings 480 are distributed in reverse. Pool 1 450 must wait for Pool 2 460 to complete and distribute the PIPA winnings 480 due Pool 1 450, and so on and so forth As in the previous example, the Pooling Service may apply a sequential-network optimization limiting the number of generations of calculation of PIPA winnings. However, when the circular part of the network is shorter than the required number of generations in the optimization, the circular network must be recalculated at least three times to minimize the distribution error in winnings. The distribution error is defined as the amount of change in PIPA winnings for a given pool after each successive winnings distribution calculation of the entire circular network.

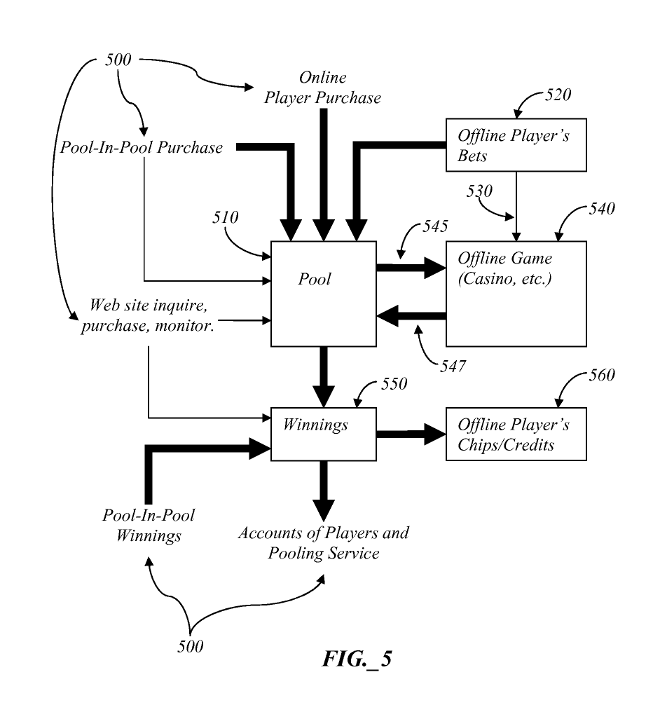

Referring, finally, to FIG. 5, there is shown in a highly schematic block diagrammatic form a method for online pooled players joining and collaborating with an offline player at a casino-style game, and the distribution of winnings from the pool. Thin lines and arrowheads signify activities on the web site or offline activities, and thick black lines and arrowheads signify the flow of funds. The process builds on the infrastructure illustrated in FIG. 1, with the same inputs and outputs 500 of the lottery-based pooling diagram, comprising: online player purchase funds going into the Pool 510, Pool-In-Pool purchase funds going into the Pool, web site inquiry, purchase, and monitoring user activity on the Pool, Pool-In-Pool winnings funds going into the Winnings 550, and Winnings paying out to online players, Pool-In-Pool players, and the Pooling Service.

Additionally, FIG. 5 depicts the method of the online pool's interaction with the offline player at an offline table game or other investment. The Offline Player's offline bets 520 are recorded in the Pool 510 along with the other Online Players. The Offline Player makes decisions and directs the game play 530. The Online Players may or may not participate in the Offline Player's decisions and actions through electronic communications means. Through a function of the Pooling Service and the gaming or investment service, e.g., casino, funds are transferred 545 from the Pool 510 into the Offline Game 540. Any resulting payout from the game or investment is transferred 547 back to the Pool electronically through actions of the gaming or investment service and the Pooling Service. At the conclusion of the gaming or investment activity, winnings 550 are transferred out of the pool account into accounts of Online Players, Pool-in-Pool Players, and the Pooling Service according to the percentage ownership in the pool. Likewise, winnings are transferred to the Offline Player as a credit in an electronic account or physical chips 560 disbursed through the gaming or investment service.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention.

Therefore, the above description and illustrations should not be construed as limiting the scope of the invention, which is defined by the appended claims.

What is claimed as invention is:

1. A method of collecting and managing pooled funds, pooled players, and/or pooled activities, and of distributing payouts online through a web site, mobile application, or desktop application, comprising:
registering players online;
providing to registered players an account infrastructure for attributes and funds;
collecting funds from players through online payment services;
tracking funds collected from players in a player's account;
providing lists of pools of registered players linked to lotteries or games, either singly or in combination;
accepting requests for purchase of a percentage share of a pool from one or more players;
recording the purchase of the percentage share of the pool in the player's account attributes;
transferring funds from the player's account to a pool account;
applying funds from the pool account to buy lottery tickets, fund bets at games, fund bets on sporting events, singly or in any combination;
receiving payouts from lotteries or games, singly or in combination; and
distributing any payouts to the players' accounts;
wherein said method increases the odds of players winning and minimizing the players' rate of loss.

2. The method of claim 1, wherein one or more players contribute funds to the pool from offline funds that include cash, casino chips, or accounts at other institutions.

3. The method of claim 2, wherein a casino mediates the transfer of funds from an offline player to the pool account.

4. The method of claim 2, wherein a non-casino institution mediates the transfer of funds from an offline player to the pool account.

5. The method of claim 1, further including purchasing a share of the lottery or game and directing a portion of any payout to the players.

6. The method of claim 1, wherein a player's percentage share in a pool will not decrease when other players participate in the pool.

7. The method of claim 1, further including the step of guaranteeing some payout to the players.

8. The method of claim 1, further including representing funds in various currencies of the world, including digital and abstract currencies.

9. The method of claim 1, further including presenting to players online an intuitive graphic display of the critical attributes of a pool suitable for visual comparison of pools, comprising the substeps of:
creating a graphic image of a three dimensional geometric shape having height and width dimensions;
setting the height of the shape to an extent representing the size of the jackpot or payout of the lottery or game attached to the pool at a consistent scaling factor;
setting the width of the shape to an extent representing the odds of the lottery or game attached to the pool at a consistent scaling factor;
setting a level indicator within the shape representing the percentage of the pool that has already been purchased by players or non-player participants; and
setting another level indicator within the shape representing the percentage of the pool that has been purchased by the player in whose context the graphic is perceived.

10. The method of claim 9, including setting the height of the shape to an extent representing the maximum possible contribution amount of money, at a consistent scaling factor, instead of the size of the jackpot.

11. The method of claim 9, including promoting to 100% the internal level representing the percentage of the pool that has already been purchased at the time the pool closes to further contributions.

12. The method of claim 9, wherein when less than 100% of the pool has been purchased, promoting to a higher level the internal level representing the percentage of the pool owned by the current user in proportion to the new total value of the pool under conditions of the pool closing to further contribution.

13. The method of claim 9, wherein when less than 100% of the pool has been purchased, reducing the width of the shape representing the odds of the lottery or game attached to the pool to a lesser extent to reflect any difference in odds relating to final total contributions to the pool under conditions of the pool closing to further contribution.

14. A method for collecting and managing of pooled funds, pooled players, and/or pooled activities, and distributing payouts online, through a web site, mobile application, or desktop application, comprising:
registering players online;
providing to registered players an account infrastructure for attributes and funds;
collecting funds from players through online payment services;
tracking funds collected from players in a player's account;
providing lists of pools of registered players linked to lotteries or games, either singly or in combination;
accepting requests for purchase of a percentage share of a pool from one or more players;
recording the purchase of the percentage share of the pool in the player's account attributes;
transferring funds from the player's account to a pool account;
applying funds from the pool account to buy lottery tickets, fund bets at games, fund bets on sporting events, singly or in any combination;
receiving payouts from lotteries or games, singly or combination; and
distributing any payouts to the players' accounts;
charging players a service fee for the service of pooling players;
wherein the statistical odds of winning and minimizing the rate of loss by way of mechanical or automated processes is increased.

15. The method of claim 14, including applying funds from the pool to purchase percentage shares in one or more other pools in addition to any lotteries, games, or bets.

16. The method of claim 14, including the step of applying funds from the pool account to multiple lotteries, games, and bets, alone or in any combination thereof.

17. The method of claim 16, further including presenting to players online an intuitive graphic display of the critical attributes of a pool suitable for visual comparison of pools, comprising the substeps of:
creating a graphic image of a three dimensional geometric shape having height and width dimensions;
setting the height of the shape to an extent representing the size of the jackpot or payout of the lottery or game attached to the pool at a consistent scaling factor;
setting the width of the shape to an extent representing the odds of the lottery or game attached to the pool at a consistent scaling factor;
setting a level indicator within the shape representing the percentage of the pool that has already been purchased by players or non-player participants; and
setting another level indicator within the shape representing the percentage of the pool that has been purchased by the player in whose context the graphic is perceived.

18. The method of claim 15, further including presenting to players online an intuitive graphic display of the critical attributes of a pool suitable for visual comparison of pools, comprising the substeps of:
creating a graphic image of a three dimensional geometric shape having height and width dimensions;
setting the height of the shape to an extent representing the size of the jackpot or payout of the lottery or game attached to the pool at a consistent scaling factor;
setting the width of the shape to an extent representing the odds of the lottery or game attached to the pool at a consistent scaling factor;
setting a level indicator within the shape representing the percentage of the pool that has already been purchased by players or non-player participants; and
setting another level indicator within the shape representing the percentage of the pool that has been purchased by the player in whose context the graphic is perceived.

19. The method of claim 1, including applying funds from the pool to purchase percentage shares in one or more other pools in addition to any lotteries, games, or bets.

20. The method of claim 1, including the step of applying funds from the pool account to multiple lotteries, games, and bets, alone or in any combination thereof.
